(19) United States
(12) Patent Application Publication
(10) Pub. No.: US 2002/0169714 A1
(43) Pub. Date: Nov. 14, 2002

(54) Ordering-and-reserving management method using paper medium mounted with radio frequency identification IC chip and advertising effect analysis method, and system thereof

(76) Inventors: Masayuki Ike, Tokyo (JP); Masakazu Ito, Tokyo (JP); Takeshi Suzuki, Tokyo (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 09/949,381

(22) Filed: Sep. 6, 2001

(30) Foreign Application Priority Data
May 10, 2001 (JP) 2001-140494

(51) Int. Cl. G06F 17/60

(52) U.S. Cl. 705/39

(57) ABSTRACT

A method of ordering-and-reserving management which is excellent in convenience of the consumer, suppresses loss of sales opportunity, and makes possible a quick and sure analysis of an advertising effect is provided. The method includes, an ID-receiving procedure (s101) for receiving the ID of the RFID chip (60) obtained from a reader-writer terminal (30); a chip-authentication procedure (s102) authenticating the validity of the RFID chip (60) conducted by performing, for the received ID, authentication in a data base (10a), or, by requesting authentication to an issuing-and-certification authority (20) which is the origin of the ID and obtaining the results; individual-information-receiving procedures (s105, s106) receiving, from a reader-writer terminal (30), an event of ordering-and-reserving demands of the customer regarding the printed products/services on a paper medium (50) and an individual-specific information which may specify the consumer; a chip-ticketing procedure (s110) corresponding the specified consumer by the individual specific information together with the ID of the authenticated RFID chip (60), in the database (10a) and the RFID chip (60), as well as recording that the ordering-and-reserving demand has been received; a result-sending procedure (s111) for sending the result of the chip ticketing to the reader-writer terminal (30).

### BACKGROUND OF THE INVENTION

The present application claims priority upon Japanese Patent Application No. 2001-140494 filed on May 10, 2001, which is herein incorporated by reference.

1. Field of the Invention

The present invention relates to a method of managing with a server computer ordering and reserving of printed products/services, by using a paper medium such as a pamphlet, a catalogue or a leaflet printed with advertising information regarding such as products/services mounted with a radio frequency identification IC chip (hereinafter referred to as “RFID chip”) which has a unique ID and stores this, and is directed for the many and unspecified consumers.

2. Description of the Related Art

Paper mediums for advertisement requesting purchase of a product/service directed for the many and unspecified consumers, such as a folded advertisement inserted in between a newspaper, a travel pamphlet or a concert poster placed outside a shop, and a mail order catalogue, have become very common. Due to the ease of distributing and manufacturing, and low cost of this paper medium, and also from the view of its popularization and establishment of its method of use, this medium is used in various industries, and general consumers often look at it with ease in the streets or at home.

However, if a consumer wishes to perform procedures for ordering and reserving a printed product/service based on information printed on a space of the paper medium, in the end it is necessary to actually go to a shop to perform the procedures, or to phone himself/herself and perform the procedures after listening to such as the product explanation.

Accordingly, for example, paying attention to the procedures of ticket reserving/ticket issuing, there is developed a technique to simplify this by use of an IC card. As such a technique, for example there is a conventional example as shown in Japanese Patent Application Laid-open Publication No. 10-134129. This technique has an aim to solve complications of the consumer reserving a ticket in advance by such as a telephone or the Internet and obtaining a reservation number and then settling the payment at an actual shop such as a ticket counter based on this reservation number, and the problem of the need of the ticket issuing agent to arrange attendants or shops to cope with the above. The technique is characterized in that by writing in reservation information or ticket information given from the ticket issuing agent on the IC card which the consumer has, this IC card becomes a medium of electronic ticket issuing.

However, in the above conventional technique, even if electronic ticket issuing is possible, the medium is always an IC card, and is not a paper medium printed with an advertisement. Therefore, for example, if a consumer takes and looks at a concert pamphlet on the street, and tries to reserve/buy the concert ticket, if that consumer does not own an IC card, reservation and purchasing has to be performed in the conventional procedures. That is, the electronic ticket reservation and possibility of the ticket issuing is influenced by whether or not the consumer has an IC card, and therefore it may not be a fundamental solution to simplify the ordering and reserving procedures related to the above described products/services. Of course, it is obvious that consumers without an IC card are lessened of their interest to purchase, further a problem may arise that since the ticket information recorded in the IC card is not visible from the outside, when the ordering and reservation of several products/services are being performed, it may be hard for the customer to manage the information by himself/herself.

In any case, from the view of the consumer performing such as ordering and reserving of products/services, the unavoidable and complicated step-by-step procedures are a bother. On the other hand, from the view of such as an advertisement provider or a ticket issuing agent there may be fear of the consumer's interest to purchase lessening due to the complicated ordering and reserving and the loss of precious sales opportunities, and meanwhile there was also a point that it was unclear whether or not the advertising effect was actually increasing.

### SUMMARY OF THE INVENTION

The present invention is made in view of the above-mentioned conventional problems, and an objective of the present invention is to provide a method for ordering-and-reserving management which is highly convenient for a consumer, suppresses the loss of sales opportunities, as well as makes a quick and certain analysis of the advertising effect possible.

A method according to an aspect of the present invention for achieving the above object is, A method for managing, with a server computer, ordering and reserving of printed products/services using a paper medium directed to many and unspecified consumers, such as pamphlets/catalogues/leaflets, printed with advertising information regarding products/services and mounted with an RFID chip with a corresponding unique ID and storing the ID therein, the method including:

an ID-receiving procedure for receiving, from a reader-writer terminal, the ID of the RFID chip obtained by a reading operation of the reader-writer terminal of the RFID chip mounted on the paper medium;

a chip-authentication procedure for authentication of the validity of the RFID chip, conducted by performing, regarding the ID received from the reader-writer terminal, authentication in a data base storing the ID corresponding to each RFID chip mounted on the paper medium, or by requesting authentication to an issuing-and-certification authority which is the origin of the ID obtaining the result of the authentication request;

an individual-specific-information-receiving procedure for receiving from the reader-writer terminal the requesting event, presented by a consumer on the reader-writer terminal, of ordering and reserving by the consumer regarding the product/service printed on the paper medium, and individual-specific information which can specify the consumer;

a chip-ticketing procedure, in the data base and the RFID chip, for corresponding the consumer, who was specified through the individual-specific information, with the ID of the RFID chip authenticated by the chip-authentication procedure, as well as recording receiving of an ordering-and-reserving demand by the consumer regarding the printed product/service of the paper medium mounted with an RFID chip; and

a result-sending procedure for sending the result of the ticketing in the chip-ticketing procedure to the reader-writer terminal.

Note that, the RFID chip in the present invention is not limited to the meaning of only the non-contact type IC chip. It is used to include the meaning of an RFID tag, in which the non-contact type IC chip storing such as the individually-allotted ID is appropriately covered by a housing of various materials, shapes and sizes.

### BRIEF DESCRIPTION OF THE DRAWINGS

For a more complete understanding of the present invention and the advantages thereof, reference is now made to the following description taken in conjunction with the accompanying drawings wherein:

FIG. 1 is an entire structural view showing the relationships of an ID management center, a server computer, a reader-writer terminal and a providing place terminal in an embodiment of the present invention;

FIG. 2 is a relational view showing the flow of information handled in the structure shown in FIG. 1;

FIG. 3 is an explanatory view showing an image of a paper medium mounted with an RFID chip in the embodiment;

FIG. 4 is an explanatory view showing a structural example of a memory layout of an RFID chip in the embodiment;

FIG. 5 is an explanatory view showing an example of an ID management table in the embodiment;

FIG. 6 is a flow chart showing the process procedures of the ordering-and-reserving management method in the embodiment;

FIG. 7 is an explanatory view showing screen transition examples of a reader-writer terminal with the process procedures of the ordering-and-reserving management method in the embodiment; and

FIG. 8 is an explanatory view showing the screen transition examples of a providing place terminal with the process procedures of the ordering-and-reserving management method in the embodiment.

### DETAILED DESCRIPTION OF PREFERRED EMBODIMENTS

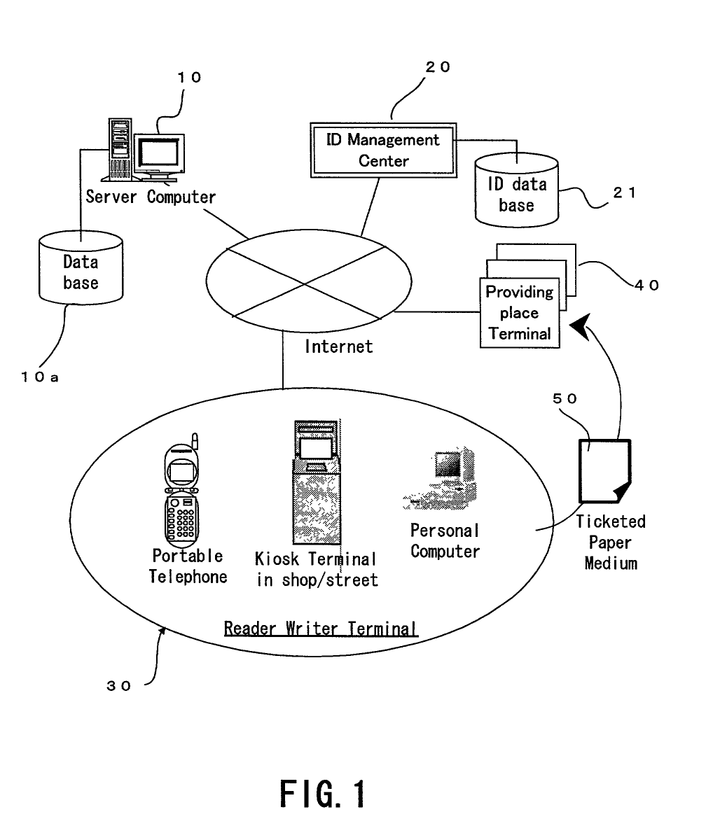

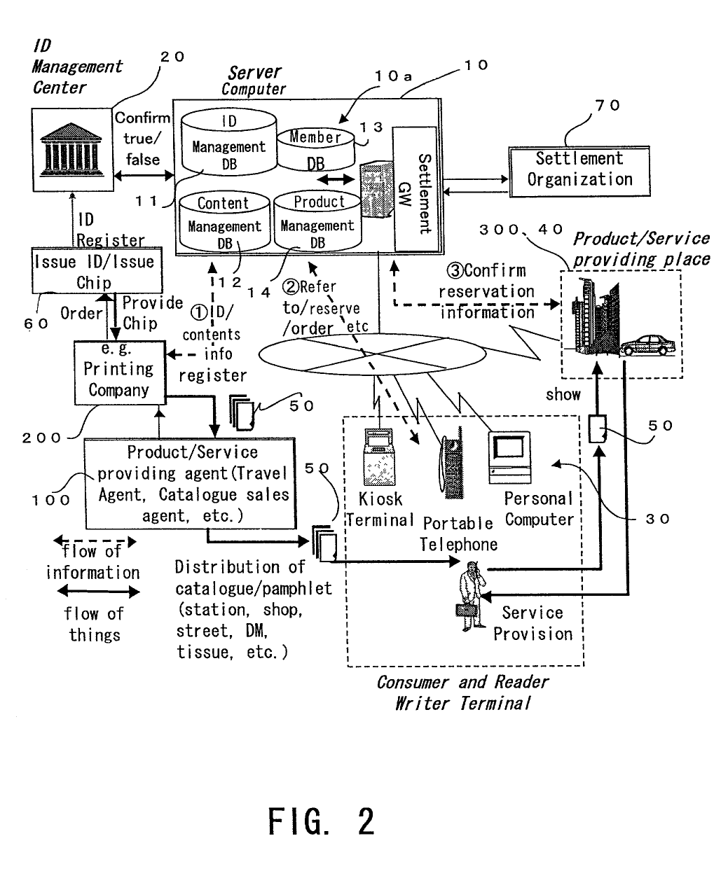

An embodiment of the present invention is described in detail below with reference to the drawings. FIG. 1 shows an entire structural view showing the relationship of a server computer 10, an ID management center 20, a reader-writer terminal 30, and a providing place terminal 40 provided in a product/service providing place 300, and FIG. 2 is a relational view showing the flow of information handled in the structure shown in FIG. 1. As a background of this embodiment, FIGS. 1 and 2 are referred to together, and the summary is first explained. A situation is assumed in which a travel agency as a product/service providing agent 100 requests a printing company 200 to manufacture a travel catalogue as a paper medium 50, the printing company 200 receives the issue-and-provision of an RFID chip 60 (includes ID issue) from the ID management center 20 (issuing-and-certification authority which is the origin of the ID) to manufacture the paper medium 50 mounted with the RFID chip 60, and the travel agency 200 distributes these to the consumers at shops, the street or the like.

In this case, when the consumer takes and looks at the travel catalogue on such as the street, and applies for a reservation of a tour that he/she likes, the reading operation of the travel catalogue 50 (i.e. the RFID chip 60) is performed by such as a kiosk terminal or a portable telephone as a reader-writer terminal 30, and a personal computer. Then, a server computer 10, worked by an ASP agent who contracts with various product/service providing agents and intensively executes the order-and-reserve management business regarding the products/services, receives the ID through a network, performs authentication of the ID, tour reservation and tour price settlement process by using the ID management center 20 and a settling organization 70, and gives instructions to recording the reservation-and-settlement completion event to the RFID chip 60 at the reader-writer terminal 30, thus making the travel catalogue 50 itself into a travel ticket. The consumer takes this travel catalogue 50 to the tour destination such as the hotel which is a product/service providing place 300, and with the providing place terminal 40 arranged there performs confirmation of his/her reservation and receives the service provided thereof.

Of course, the application of the present invention is not limited to only this embodiment which assumes the situation where the travel agency distributes the travel catalogue mounted with the RFID chip to the consumers and the ASP agent conducts the tour reservation management, but it is needless to say that it may be applied to any business situations using a paper medium as publicity, and which needs to perform ordering-and-reserving management of the printed products/services.

The system shown in FIG. 1 receives the ID of the RFID chip 60 mounted on the paper medium 50 from the reader-writer terminal 30 through a network such as the Internet; authenticates this ID and orders and reserves the printed product/service by using the ID management center 20 or the settlement organization 70, and performs the price settlement process; and gives the instruction for recording to the RFID chip 60 in the reader-writer terminal 30 of the reserving-and-settlement completion. This system is structured by the server computer 10 which makes the travel catalogue 50 itself into a ticket, the ID management center 20 which is connected to the server computer 10 through such as the Internet and is an issuing-and- certification authority of the ID of the RFID chip 60, the reader-writer terminal 30 which is used by the consumer performing such as ordering and reserving of the printed products/services on the paper medium 50 such as a travel catalogue, and a providing place terminal 40 which is placed in the providing place of the printed products/services on the paper medium 50.

The server computer 10 is worked by the ASP agent (or the product/service providing agent itself), and takes in the ID of the RFID chip 60 from the reader-writer terminal 30 through such as the Internet by an appropriate communication device, then requests for an inquiry of this ID at the ID management center 20 and obtains the authentication result, or performs the inquiry operation with the registered ID in the data base 10a (i.e. the ID management data base 11) provided therein to thus perform authentication. Moreover, if it is necessary, or according to the request of the consumer, product/service information more detailed than that printed on the paper medium 50 is transmitted from a content management data base 12 to the reader-writer terminal 30 and shown to the consumer.

The ID management data base 11 in the data base 10a, for example, is such which receives the ID information from the ID data base 21 in the ID management center 20 at an appropriate timing and copies it, and corresponds the RFID chip 60 mounted on the paper medium 50 managed by the ASP agent with the ID, and records it. The content management data base 12 is a data base storing voice, picture, image and other various information that cannot be transmitted by the paper medium 50, such information being related to the ID of the RFID chip 60 mounted on the paper medium 50.

Further, the server computer 10 is provided with a member data base 13. This member data base 13 suitably obtains personal information of the consumers who are to become members of the ordering-and-reserving service of the products/services using the paper medium 50 mounted with an RFID chip 60 provided by a product/service providing agent or an ASP agent through some means such as an enter form delivery on the web screen, electronic mail, mail, hand delivery, telephone or fax; and accumulates and manages the personal information using, for example, the member ID as the key. Besides, the server computer 10 has a product management data base 14, and in this data base, for every ID of the RFID chip 60, ordering and reserving or settlement situation of the product/service corresponding to the relevant ID, the effective period of the paper medium 50, the distributing area and the like are formed into a record to structure a relational table.

The server computer 10 may of course function as a web server or a mail server. Note that, the ID management data base 11, the contents management data base 12, the member data base 13 and the product management data base 14 as the data base 10a, are provided in an appropriate storing device, for example a hard disk or the like, and for example may be intensively integrated in the ID management data base 11 using the ID of the RFID chip 60 as the key. Or perhaps, they may be organically connected to each other by a network and effectively operable.

The server computer 10 connects with the settlement organization 70 such as an outside financial organization 70, and performs the settlement process for the price of the printed products/services on the paper medium. At that time, various monetary information and the like are exchanged with the settlement organization via the settlement gateway. Of course, when the ASP agent fulfils the role of the settlement organization, there is no problem if the server computer 10 itself bears the settlement business and internally processes everything.

The ID management center 20 issues the ID of the RFID chip 60, and further issues the RFID chip 60 which has recorded that ID, as well as takes the request of the server computer 10 to perform an authenticity confirmation that the RFID chip 60 is valid via the authentication operation of the ID taken from the reader-writer terminal 30. So to speak, it may be called the ID issuing and certification authority. The ID is issued in a one-to-one relationship with the RFID chip 60 without overlapping with others, and is stored and managed in the ID data base 21. The issuing of the ID and the RFID chip 60, is contracted from such as a printing company 200 receiving the request from the product/service providing agent 100, and the RFID chip 60 may be provided to the printing company 200.

The reader-writer terminal 30 is to be used by the consumers, and is such as a personal computer, a portable telephone which may connect to the Internet, or a kiosk terminal set in a kiosk and may communicate with the server computer 10 through a network, which in any case has a reader-writer function in respect to the RFID chip. The consumer accesses the server computer 10 using this reader-writer terminal 30, and performs the “ticketing” of the paper medium 50.

Note that, if the above server computer 10 and the ID management center 20 can attempt sharing of the ID of the RFID chip 60 in the data base 10a (i.e. the ID management data base 11) and in the ID data base 21 while maintaining security and synchronicity, it may be an integral computer or maybe organically combined through such as the network. Further, the reader-writer terminal 30 and the providing place terminal 40 are not limited to just a general personal computer, a portable telephone connectable to a network or a kiosk terminal as shown in the figure, but if it is connectable to a network and has a reader-writer function of the RFID chip, it may be a machine, such as a PDA, a game machine, a digital TV, or a fax machine, provided with any of the computer chips. Additionally, a network which connects at least any of the server computer 10, the ID management center 20, the reader-writer terminal 30 and the providing place terminal 40 may use not just the Internet, but also various networks such as a personal computer transmission line, a LAN, and a radio network.

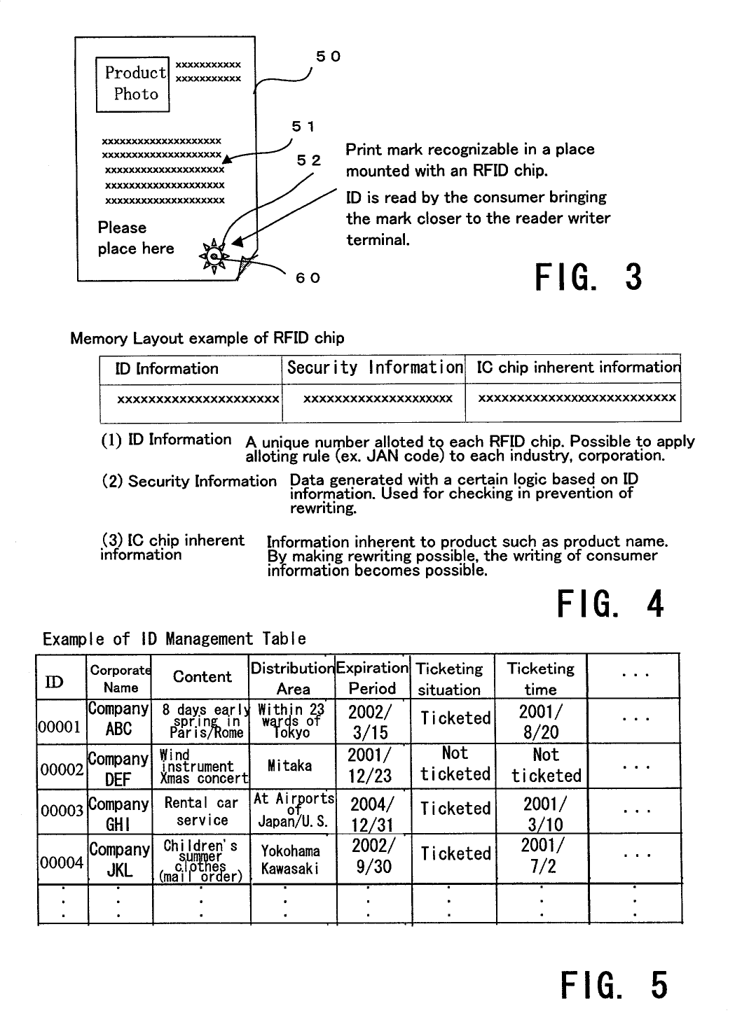

FIG. 3 is an explanatory view showing an image of the paper medium mounting the RFID chip in the embodiment. The paper medium 50 mounted with the RFID chip 60 is, for example, assumed to be such as in FIG. 3. As the paper medium 50 printed with the advertisement information 51, there may be considered a travel or hotel catalogue, a concert poster, a mail order catalogue, a car rental catalogue, an advertising paper of shop guides which is inserted in such as the back of a pocket tissue, and all sorts of paper mediums for advertisement. Usually in such a space, there is a product photo or an image view, and a publicity slogan or the like is printed as an advertising information 51. For example, at the lower portion a mark 52 is printed so that the place where the RFID chip 60 is mounted may be determined, and an RFID chip 60 is to be mounted within this mark 52. In this way, by the consumer bringing the paper medium 50 close to the reader-writer terminal 30 with this mark 52 at the center, the reading of the ID of the RFID chip 60 may be more simply and surely executed. 22.

FIG. 4 is an explanatory view showing a structural example of a memory layout of an RFID chip in the embodiment. Next, the internal portion of the RFID chip 60 is paid attention to. The RFID chip 60 is a so-called non-contact type IC chip, has an antenna inside, and through the antenna electric supply and the reading and writing of data from the reader-writer terminal 30 becomes possible. The structure comprises CPU, RAM, ROM, EEPROM and the like, and the ID is recorded in, for example, a nonvolatile read only ROM or an EEPROM which is nonvolatile and may be electrically rewritten or erased. As shown in the diagram, a memory layout is structured by an ID information, a security information and an IC chip inherent information. ID information is a unique number which is allotted to every RFID chip 60, and the allotting rule may be applied as like a JAN code for every type of business or corporate. Security information is data which is generated with a certain logic (for example, RSA, 3DES or the like in a code key method) based on the ID information, and is used for checking in the prevention of false altering. The IC chip inherent information is, for example recorded in the EEPROM, and may include information inherent to a product such as a product/service name corresponding to the relevant RFID chip 60, as well as performing write in of various information such as individual specific information of the consumer who has performed ordering-and-reservation or settlement.

FIG. 5 is an explanatory view showing an example of an ID management table in the embodiment. This ID management table is, for example provided in the product management data base 14 in the data base 10a or the ID management data base 11. Here, the ID is the key, and a name of the product/service providing agent (corporate name) who provides the printed product/service of the paper medium 50 mounted with an RFID chip 60 which corresponds to the ID, the advertising content of the paper medium 50 (contents), the distributing area of the paper medium 50, the expiration date, the ticketing situation showing whether or not the consumer has a ticket, the date of the ticketing, and the like may be the data for forming a record for every ID. These data are provided by, for example a printing company 200 who manufactured the paper medium 50, and is appropriately accumulated/updated. Further, data of the ticketing situation and the ticketing date is re-written when ticketing is actually performed. For example, the data and the consumer's attribute may be both statistically processed together, and may come into use for marketing analysis to see when and where a person with what attribute reserved which product/service.

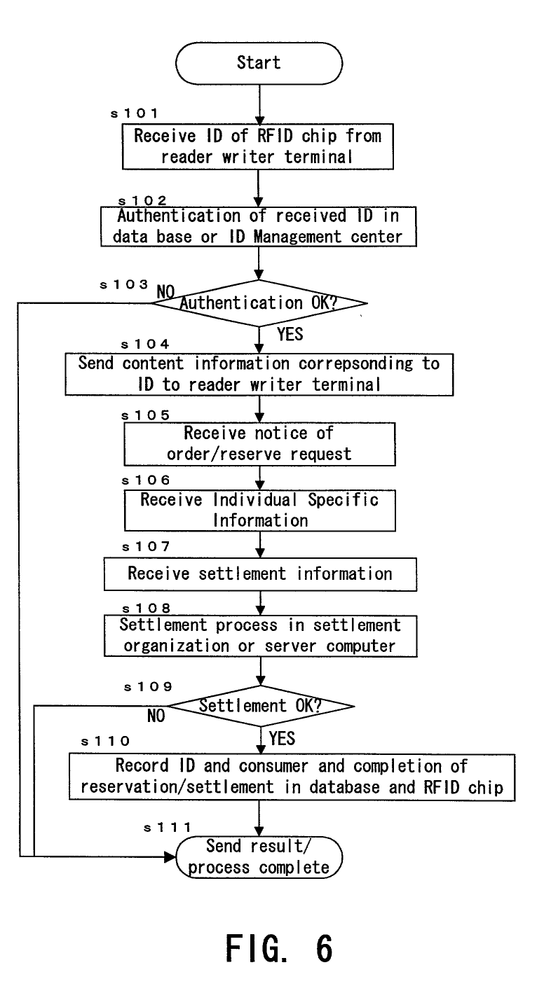

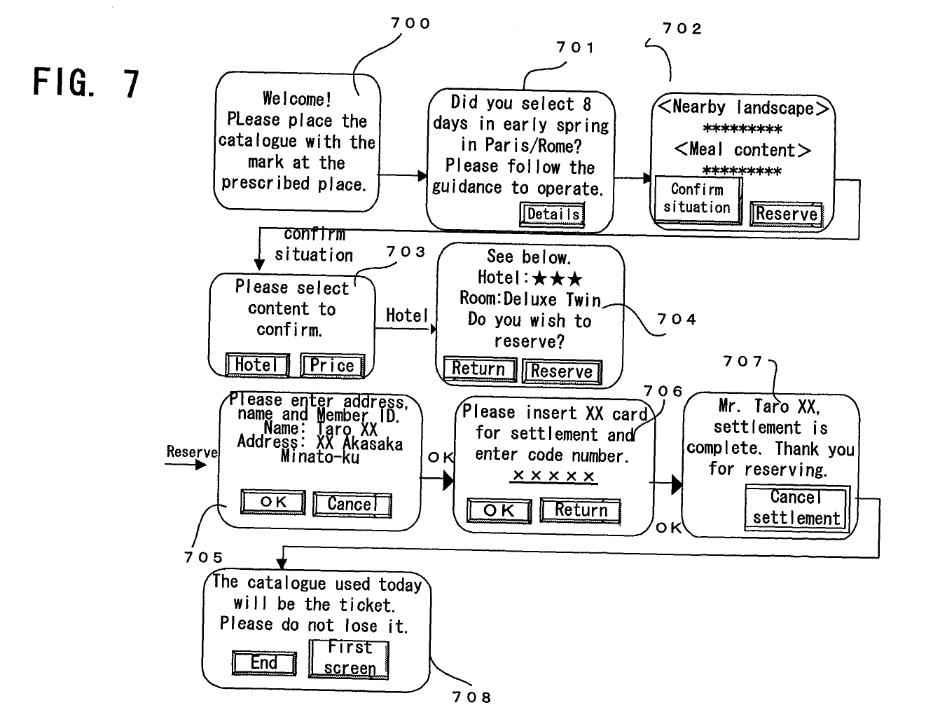

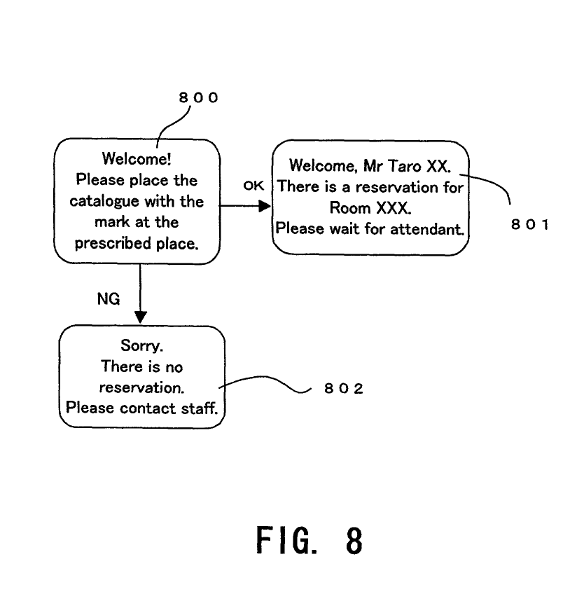

FIG. 6 is a flow chart showing the processing procedures of the ordering-and-reservation management method in the embodiment; FIG. 7 is an explanatory view showing an example of screen transitions of the reader-writer terminal with the processing procedure of the ordering-and-reservation management method in the embodiment; and FIG. 8 is an explanatory view showing an example of the screen transitions of the providing place terminal with the processing procedure of the ordering-and-reservation management method in the embodiment. Hereinbelow, the actual procedures of the ordering-and-reservation management method of the present invention are shown together with the screen transitions in the reader-writer terminal 30. For example, in the afore-mentioned ID management table in FIG. 5, regarding a tour product with an ID 00001 and shown as “8 day trip early spring in Paris and Rome” by company ABC, a consumer obtains a relevant travel catalogue (as a paper medium 50) on the grounds of a train station and tries to perform the reservation and settlement of the tour then and there. For example, the consumer brings the relevant travel catalogue close to or on the predetermined portion of a kiosk terminal placed on the grounds of the station as a reader-writer terminal 30 in accordance with the screen display 700 of the kiosk terminal.

Then, the kiosk terminal performs the ID reading operation of the RFID chip 60 mounted on the travel catalogue in the reader-writer portion, and sends the ID:00001 to the server computer 10 through the network. This is received by the server computer 10 (step s101), an authentication request is made to the ID management center 20 to authenticate this ID:00001 and the authentication result is obtained, or authentication is performed in the ID management data base 11 of the data base 10a managed by the server computer 10 (s102). If authentication of this ID fails here, and the RFID chip 60 is false or the ID:00001 is determined as wrongly rewritten (s103), such notice is sent to the kiosk terminal to be screen displayed, and the process ends.

If the authentication succeeds (s103), to confirm the understanding of the consumer regarding the tour product that corresponds to the ID:00001, as in screen 701, a confirmation display is performed. Here, when the consumer desires to see the details of the tour product, and clicks such a button, such an event is sent to the server computer 10 from the kiosk terminal, and the server computer 10 draws out a contents information regarding the tour product corresponding to the ID:00001 from the contents management data base 12, and sends it back to the kiosk terminal (s104).

The consumer confirms the attractions of the tour product such as the landscape of the travel destination or the meal contents at the content display screen 702, and further performs situation confirmation regarding the various conditions of the trip. The contents to be confirmed in screen 703 (for example, hotel) is selected by the consumer, and when the selection event is sent to the server computer 10 through the network, the server computer 10 draws out for example the relevant hotel information from the contents management data base 12 and sends this back to the kiosk terminal. The consumer confirms the information regarding the hotel to stay at the travel destination, whereupon a decision to reserve is made. When the consumer clicks the reservation button at this screen 704, this reservation-demanding event is sent to the server computer 10.

The server computer 10 receives this (s105), and sends back an enter-request form of individual specific information in accordance with the ID:00001. The consumer enters the address, name, contact place or member ID in the enter request form displayed in the screen 705 and clicks the OK button. This screen may be a member-registered screen.

The individual specific information entered by the consumer is sent to the server computer 10 from the kiosk terminal, and is received by the server computer 10 (s106). If a member ID is included in the individual specific information received, the member authentication is performed by the member data base 13, and on the other hand when the member ID is not included, it is considered that it is the first time of use and registration to the member data base 13 is performed.

Then, with this individual specific information, if it is considered that the consumer is already a member, or the individual consumer maybe specified since the address, the name, the contact place and the like is clear, an enter-request form of settlement information is sent from the server computer 10 to the kiosk terminal. The consumer, in accordance with the instruction of the screen 706 where the enter-request form of the settlement information is displayed, inserts a settlement card such as a credit card or a debit card in possession to a predetermined reader of a kiosk terminal, and enters a card number and a code number. This settlement information is received by the server computer 10 from the kiosk terminal (s107), the server computer 10 draws out a price information of the tour product corresponding to the ID:00001 from for example the contents management data base 12, and attaches it to this settlement information. The settlement information attached with this price information is transferred to the settlement organization 70 via the settlement gateway.

The settlement organization 70 performs authentication of the information regarding the settlement card based on the settlement information received, and then performs the settlement by such as drawing out from a predetermined account of the consumer the price of the tour product which is reserved and is requested settlement by a consumer (s108). If settlement ends normally, in the ID management table and the memory area of the IC chip inherent information of the RFID chip 60, through using the RFID chip 60 ID:00001 as the key, the consumer specified by the individual specific information may be made to correspond, for example, by his/her member ID (it may be the entire individual specific information) and is recorded, the reservation request by the consumer of the tour product is received, and the event that the settlement is complete is recorded (s110). In this way the RFID chip 60 is recorded with data which indicates that reservation and settlement has been completed normally by the specific consumer regarding the tour product, and the RFID chip 60 is “ticketed”, i.e., the RFID chip 60 itself is deemed to be a ticket.

The result of the ticketing is sent to the kiosk terminal from the server computer 10 (sill), the consumer views the display screen 707, and knows that the series of processes from reservation to settlement regarding the tour product has completed smoothly. In the last screen 708, for example, it is shown that the travel catalogue has been ticketed, and an appropriate management is urged to the consumer. At this time, for example, appropriate print data for printing letters or printing images such as a shadow picture, a character and letters showing that the ticketing of the RFID chip 60 is complete may be transmitted to the kiosk terminal by the server computer 10, and a printing instruction, such as to print out the print data onto the travel catalogue, may be sent to a printing facility provided within or connected to the kiosk terminal.

The consumer heads for the travel destination with the travel catalogue which has been ticketed, and arrives at, for example the destination hotel in the tour (product/service providing place 300). The consumer places the travel catalogue near or on the providing place terminal 40 provided in such as the lobby of the hotel and which has a similar function as the kiosk terminal. The instruction screen at that time is screen 800. The providing place terminal 40 reads the ID of the RFID IC chip mounted on the relevant travel catalogue and requests for authentication of the ID:00001 to the server computer through the network.

In the server computer 10, authentication at the ID management center 20 and the ID management data base 11 similar to the above regarding this ID:00001 is performed, and if authentication is OK, the result is sent back. Or, the reservation-and-settlement contents corresponding to the ID:00001 is drawn out from the ID management table and is sent back. At the providing place terminal 40, with this authentication result, such as the name of the consumer, the reserved room number and the days of stay are displayed at the screen 801. On the other hand, if ID authentication fails, such notice is sent back to the providing place terminal 40, and a display saying that there is no reservation at screen 802 is performed and the process is completed.

As described above, when various consumers perform multiple reservations and settlements of multiple products/services such as tour products using the paper medium 50 of such as a travel catalogue, the consumption record is accumulated in the ID management table of the server computer 10. This record becomes data which may be effectively used in the field of marketing. It is suitable to compare the information of the paper medium 50, such as the distribution area, the distribution period, the distributed subjects, the distributed amount, with the content of the advertisement information which are accumulated in the ID management table, and the attribute of the consumer identified from the individual specific information regarding the consumer who performed the ordering-and-reserving of the printed product/service through this paper medium, and to analyze the advertising effect regarding the paper medium.

An embodiment according to the present invention may be as follows. The above method includes: a settlement-information-receiving procedure for receiving, from the reader-writer terminal, settlement information originating from the consumer such as a card number and a PIN number of various cards provided with settlement functions which the consumer possesses, or the account number and the PIN number of the settlement account; a settlement-process procedure, conducted in the server computer or a settlement organization computer connected to the server computer, for settlement process of the price of the printed product/service which was ordered and reserved by the consumer, based on the received settlement information; a ticket-settlement procedure, conducted in the data base or the RFID chip, for recording the event of completion of the settlement-process procedure as well as corresponds with the consumer together with the ID; and the settlement-result-sending procedure for sending the result of the ticket-settlement procedure to the reader-writer terminal. According to this embodiment, it becomes possible to perform the settlement process regarding the printed product/service coupled with the ordering-and-reserving process.

Further, in the above method, the settlement information is included in the individual specific information, and the settlement-information-receiving procedure is included in such as the individual-specific-information-receiving procedure. According to this embodiment, it becomes possible to further perform the settling process easier and quicker.

Further, in the above method, the ticket-settlement procedure is included in the chip-ticketing procedure. According to this embodiment, it is possible to perform the settlement process easier and faster.

Further, according to the method, an appropriate print-image data showing that the chip-ticketing procedure or the ticket-settlement procedure has completed is sent to the reader-writer terminal which is mounted on a printer or connected thereto or is provided with a printing function, and then an instruction to print to the paper medium is performed. According to this embodiment, together with the authentication function provided in the RFID chip and the security function, it becomes possible to help further improve reliability of the paper medium which has been ticketed.

Further, an advertising-effect-analysis method is structured characterized in that: the distribution information including at least any of the distribution area, the distribution period, the distributed subjects, the distributed number, and the contents of the advertising information is recorded in the data base related with the ID of the RFID chip mounted on the paper medium; the attribute of the consumer, identified from the individual-specific information regarding the consumer performing the ordering and reserving of the printed product/service through the paper medium, is compared with the distribution information corresponding to the ID of the RFID Chip used by the consumer for the ordering and reservation; and the advertising effect relating to the paper medium is analyzed. According to this embodiment, it becomes possible to perform analysis with certainty of the advertising effect by the paper medium which was not clear in the past.

Further a system is created which can be realized by the computer conducting the above-mentioned method.

In the embodiment according to the present invention, the following effects are seen. The ordering-and-reserving procedures of the product/service printed on the paper medium may be conveniently and smoothly performed without greatly decreasing the consumer's interest for purchase when the customer looks at the paper medium printed with the advertisement. Further, since the paper medium itself printed with the advertising information becomes a ticket of the product/service printed on the paper medium, if the advertising information of the paper medium is recognizable in anyway such as by sight or by touch, then management of the ordering-and-reserving situation by the consumer himself/herself is extremely convenient, and also may be surely conducted even when performing ordering and reserving of many products/services. Further, from such as the advertisement provider and ticketing issuer side, it becomes possible to suppress loss of purchase interest or sales opportunities of the consumer due to the convenience of ordering and reserving. Further, it becomes possible to clearly analyze the actual advertising effect. Of course, since this leads to reducing the actual shops conducting provision and sending of the above products/services and the number of staffs needed for this, the reduction of investment in equipment, personnel expenses and the like may be realized.

According to the present invention, an ordering-and-reserving management method which is excellent for the convenience of the consumer, suppresses loss of sales opportunities, and makes quick and sure analysis of the advertising effects may be provided.

Although the preferred embodiment of the present invention has been described in detail, it should be understood that various changes, substitutions and alternations can be made therein without departing from spirit and scope of the inventions as defined by the appended claims.

What is claimed is:

1. A method for managing, with a server computer, ordering and reserving of printed products/services using a paper medium directed to many and unspecified consumers, such as pamphlets/catalogues/leaflets, printed with advertising information regarding products/services and mounted with an RFID chip with a corresponding unique ID and storing the ID therein, the method including:
an ID-receiving procedure for receiving, from a reader-writer terminal, the ID of the RFID chip obtained by a reading operation of said reader-writer terminal of the RFID chip mounted on said paper medium;
a chip-authentication procedure for authentication of the validity of the RFID chip, conducted by performing, regarding the ID received from said reader-writer terminal, authentication in a data base storing the ID corresponding to each RFID chip mounted on said paper medium, or by requesting authentication to an issuing-and-certification authority which is the origin of said ID obtaining the result of the authentication request;
an individual-specific-information-receiving procedure for receiving from said reader-writer terminal the requesting event, presented by a consumer on said reader-writer terminal, of ordering and reserving by the consumer regarding the product/service printed on said paper medium, and individual-specific information which can specify the consumer;
a chip-ticketing procedure, in said data base and the RFID chip, for corresponding the consumer, who was specified through the individual-specific information, with the ID of the RFID chip authenticated by said chip-authentication procedure, as well as recording receiving of an ordering-and-reserving demand by the consumer regarding the printed product/service of the paper medium mounted with said RFID chip; and
a result-sending procedure for sending the result of the ticketing in said chip-ticketing procedure to said reader-writer terminal.

2. A method as claimed in claim 1, characterized in including
a settlement-information-receiving procedure for receiving, from said reader-writer terminal, the settlement information originating from the consumer such as a card number and PIN number thereof of various cards owned by the consumer and having a settlement function, or an account number or a PIN number of a settlement account;
a settlement-process procedure, in the server computer or a computer of a settlement organization which is connected with said server computer, for settling and processing the price of said printed product/service ordered and reserved by the consumer, based on said received settlement information;
a ticket settling procedure, in said data base or the RFID chip, for corresponding the consumer with said ID and recording a completion event of said settling-process procedure; and
a settlement-result-sending procedure for sending the result in said ticket-settling procedure to said reader-writer terminal.

3. A method as claimed in claim 1 wherein said settlement information is included in said individual-specific information, and said settlement-information-receiving procedure is included in said individual-specific-information-receiving procedure.

4. A method as claimed in claim 1 wherein said ticket-settling procedure is included in said chip-ticketing procedure.

5. A method as claimed in claim 1 wherein appropriate print data indicating that said chip-ticketing procedure or said ticket-settling procedure is completed, is sent to said reader-writer terminal mounted on a printer or connected thereto or having a printer function, and instruction to print to said paper medium is performed.

6. An advertising-effect-analysis method wherein a distribution information, including any of a distribution area, a distribution period, a distributed subject, a distributed number, and a content of the advertising information of said paper medium, is recorded in said data base while being related with an ID of an RFID chip mounted on the paper medium; an attribute of a consumer, determined from said individual specific information regarding the consumer performing the ordering and reserving of the printed product/service through said paper medium, is compared with said distribution information corresponding to the ID of the RFID chip used for ordering and reserving by the consumer; and an advertising effect regarding said paper medium is analyzed.

7. A system realized by making a computer execute managing of ordering and reserving of said printed products/services using a paper medium directed to many and unspecified consumers, such as pamphlets/catalogues/leaflets, printed with advertising information regarding products/services and mounted with an RFID chip with a corresponding unique ID and storing the ID therein, the method including:
an ID-receiving procedure for receiving, from said reader-writer terminal, the ID of the RFID chip obtained by a reading operation of the reader-writer terminal of the RFID chip mounted on said paper medium;
a chip-authentication procedure for authentication of the validity of the RFID chip, conducted by performing, regarding the ID received from the reader-writer terminal, authentication in a data base storing the ID corresponding to each RFID chip mounted on said paper medium, or by requesting authentication to an issuing-and-certification authority which is the origin of said ID obtaining the result of the authentication request;
an individual-specific-information-receiving procedure for receiving from said reader-writer terminal the requesting event, presented by a consumer on the reader-writer terminal, of ordering and reserving by the consumer regarding the product/service printed on said paper medium, and individual-specific information which can specify the consumer;
a chip-ticketing procedure, in said data base and the RFID chip, for corresponding the consumer, who was specified through the individual-specific information, with the ID of the RFID chip authenticated by said chip-authentication procedure, as well as recording receiving of an ordering-and-reserving demand by the consumer regarding the printed product/service of the paper medium mounted with said RFID chip; and
a result-sending procedure for sending the result of the ticketing in said chip-ticketing procedure to said reader-writer terminal.
